(19) United States
(12) Patent Application Publication
(10) Pub. No.: US 2011/0058459 A1
(43) Pub. Date: Mar. 10, 2011

(54) METHOD AND DEVICE FOR ADJUSTING TILT OF RECORDING MEDIUM

(75) Inventors: Bong Sik Kwak, Anyang-si (KR); Jeong Kyo Seo, Anyang-si (KR); Seong Hun Lee, Seoul (KR); Do Hyeon Son, Seoul (KR)

(73) Assignee: LG ELECTRONICS INC., Seoul (KR)

(21) Appl. No.: 12/991,157

(22) PCT Filed: Apr. 16, 2009
(86) PCT No.: PCT/KR2009/001962

§ 371 Date: Nov. 5, 2010

(30) Foreign Application Priority Data
May 7, 2008 (KR) 10-2008-0042463

(51) Int. Cl. G11B 7/00

(52) U.S. Cl. 369/44.32; G9B/7

(57) ABSTRACT

A tilt control method of a recording medium comprises fixing the recording medium to a recording reproducing apparatus; performing first tilt compensation in a state that the recording medium is stopped; and performing second tilt compensation in a state that the recording medium in which the first tilt compensation has been performed is rotated.

### TECHNICAL FIELD

The present invention relates to a tilt control method and apparatus of a recording medium, and more particularly to, a tilt control method and apparatus of a recording medium, which can automatically compensate a tilt error occurring between a recording medium and a lens of an optical recording apparatus.

### BACKGROUND ART

As a demand for high quality moving picture processing increases due to consumer's upgraded taste, a large-scaled optical storage disk is required. In this respect, an optical recording medium of high density, which can record and store video data of high picture quality and audio data of high sound quality for a long time, has been recently developed.

Examples of the optical recording medium include blue-ray disk and HD-DVD. The DVD has a recording capacity of 4.7 GB, approximately, while the blue-ray disk has a recording capacity of 25 GB, approximately.

recording capacity of 25 GB, approximately.

Since such an optical recording medium of high density, an optical recording device of high density based on techniques such as super-RENS, Holography, and near field recording has been developed.

The near field recording technique is provided with a near field lens such as a solid immersion lens (SIL) to have a high numerical aperture equivalent to 2, thereby increasing recording density. The near field recording disk has a recording capacity of 140 GB to 160 GB, and should have a numerical aperture higher than that of an exist optical disk to record data at ultra-high density in a disk. Accordingly, a solid immersion lens (SIL) having a shape such as hemisphere is formed on a front surface of an object lens to increase a numerical aperture. A near field optical system which achieves such near field information recording technique enables high density recording and reproduction by overcoming diffraction limitation of a far field using the SIL.

Generally, in an optical disk recording and reproducing apparatus, an optical pickup reads data recorded on a surface of an optical disk by irradiating laser to the optical disk and detecting intensity of light reflected on the optical disk. At this time, for exact reading of data, the optical pickup should be arranged to be perpendicular to the surface of the optical disk.

However, the optical disk fails to be arranged to be exactly perpendicular to the optical pickup due to a problem occurring in a fabricating process. The case where the optical disk is not perpendicular to the optical pickup will be referred to as a tilt. In order to compensate such a tilt, it is necessary to control the tilt so that the optical pickup is perpendicular to the optical disk.

Particularly, in the near field optical recording apparatus, since the distance between the disk and a lens is very narrow, a tilt margin between them is very narrow. If the tilt margin is narrow, it is impossible to obtain stable servo, and scratch may occur due to collision between the disk and the lens.

### DETAILED DESCRIPTION OF THE INVENTION

Accordingly, the present invention is directed to a tilt control method and apparatus of a recording medium, which substantially obviates one or more problems due to limitations and disadvantages of the related art.

An object of the present invention is to provide a tilt control method and apparatus of a recording medium, which can efficiently compensate a tilt error occurring between a recording medium and a lens of an optical recording apparatus.

To achieve these objects and other advantages and in accordance with the purpose of the invention, as embodied and broadly described herein, a tilt control method of a recording medium according to the present invention comprises fixing the recording medium to a recording reproducing apparatus; performing first tilt compensation in a state that the recording medium is stopped; and performing second tilt compensation in a state that the recording medium in which the first tilt compensation has been performed is rotated.

The step of performing first tilt compensation includes detecting a gap error signal from the recording medium; and controlling an angle of the recording medium based on the detected gap error signal.

The step of controlling an angle of the recording medium includes controlling a tilted angle in a radial direction of the recording medium; and controlling a tilted angle in a tangential direction of the recording medium.

The angle of the recording medium is controlled so that the gap error signal reaches a minimum value.

The step of performing second tilt compensation includes detecting a gap error signal in a state that the recording medium is rotated; and controlling an angle of the recording medium based on the detected gap error signal.

The step of controlling an angle of the recording medium includes controlling a tilted angle in a radial direction of the recording medium; and controlling a tilted angle in a tangential direction of the recording medium.

The angle of the recording medium is controlled so that size variation of the gap error signal is minimized.

The recording medium is a near field optical recording medium, and the recording reproducing apparatus is a near field optical recording reproducing apparatus.

In another aspect of the present invention, a tilt control apparatus of a recording medium comprises a tilt driver controlling a tilted angle of the recording medium; and a tilt controller controlling the tilt driver to perform tilt control in each of a state that the recording medium is stopped and a state that the recording medium is rotated.

The tilt driver includes a first tilt driver controlling a tilted angle in a tangential direction of the recording medium; and a second tilt driver controlling a tilted angle in a radial direction of the recording medium.

The tilt control apparatus further comprises a gap error signal detector detecting a gap error signal from the recording medium, wherein the tilt controller controls the tilt driver based on the gap error signal input from the gap error signal detector.

The tilt controller controls the tilt driver to obtain a minimum value of the gap error signal in a state that the recording medium is stopped.

The tilt controller controls the tilt driver so that size variation of the gap error signal is minimized.

According to the tilt control method and apparatus of the present invention, a tilt error between the recording medium and the lens can be compensated automatically. As a result, more improved reproduction quality can be obtained and reliability of the system can be obtained.

### BRIEF DESCRIPTION OF THE DRAWINGS

FIG. 1 is a flow chart illustrating a tilt control method of a recording medium according to the embodiment of the present invention;

FIG. 2 is a brief diagram illustrating a tilt between a recording medium and a lens of a recording reproducing apparatus;

FIG. 3 is a graph illustrating a relation between a tilt angle and a gap error signal in a state that a recording medium is stopped;

FIG. 4 is a graph illustrating a relation between variance of a tilt angle and a gap error signal in a state that a recording medium is rotated;

FIG. 5a and FIG. 5b are graphs illustrating a size of a time variable gap error signal at specific tilt angles of FIG. 4;

FIG. 6 is a block diagram illustrating a tilt control apparatus of a recording medium according to the embodiment of the present invention;

FIG. 7a and FIG. 7b are plane view and sectional view illustrating a recording reproducing apparatus according to the embodiment of the present invention;

FIG. 8a and FIG. 8b are plane view and sectional view illustrating a first tilt driver and a disk driver;

FIG. 9a and FIG. 9b are plane view and sectional view illustrating a configuration of a first tilt driver;

FIG. 10 is a block diagram illustrating a recording reproducing apparatus according to the embodiment of the present invention; and

FIG. 11 is a flow chart illustrating a tilt control method of a recording medium according to the second embodiment of the present invention.

### BEST MODE FOR CARRYING OUT THE INVENTION

Hereinafter, the preferred embodiments of the present invention will be described with reference to the accompanying drawings so that a person with ordinary skill in the art to which the present invention pertains carries out the present invention.

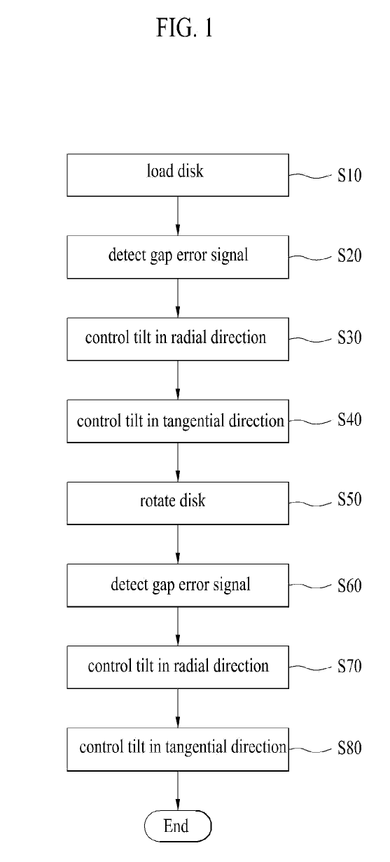

Hereinafter, a tilt control method according to the embodiment of the present invention will be described in detail. FIG. 1 is a flow chart illustrating a tilt control method of a recording medium according to the embodiment of the present invention. Hereinafter, a near field recording (NFR) medium based on near field optics will be described as a recording medium.

Accordingly, a tilt means a gradient occurring between a recording medium and a solid immersion lens (SIL) provided in an optical recording reproducing apparatus using near field.

First of all, after a recording medium is loaded in a recording reproducing apparatus (S10), a gap error signal is detected (S20) in a state that the recording medium is stopped, and a tilt is controlled based on the gap error signal (S30, S40) in a state that the recording medium is stopped.

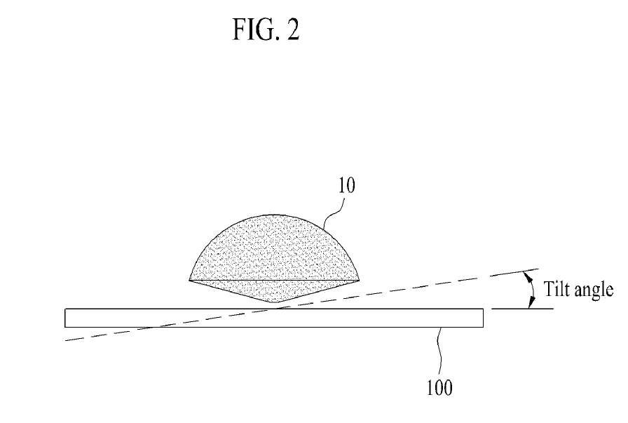

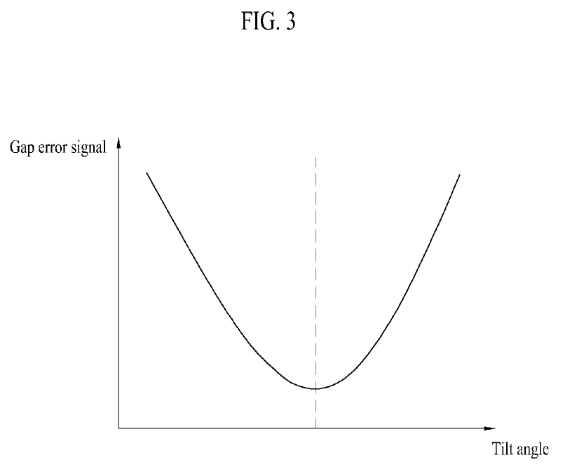

The gap error signal used to compensate a tilt error is detected through a photodiode of a pickup. FIG. 2 is a brief diagram illustrating a tilt between a recording medium and an SIL 10 of a recording reproducing apparatus, and FIG. 3 is a graph illustrating a gap error signal with respect to the tilt.

As illustrated in FIG. 3, if the SIL 10 is parallel with the recording medium, the gap error signal is minimized. If a tilt error increases as a tilt angle of the recording medium 100 increases, the gap error signal increases.

In order to minimize a tilt error, the angle of the recording medium 100 should be controlled to minimize the gap error signal. At this time, the tilt between the recording medium 100 and the SIL 10 can be divided into a tilt component in a radial direction and a tilt component in a tangential direction.

A tilt control method will be described in detail. First of all, a tilt in a radial direction is controlled (S30). If a level of the gap error signal is measured, the recording medium is titled at a predetermined angle with respect to the SIL. At this time, it is determined whether the gap error signal level is reduced or increased. If the gap error signal level is increased, since it means that the tilt is more increased, the recording medium is tilted at a predetermined angle in an opposite radial direction.

If the initial gap error signal level is reduced, or if the gap error signal level is collected to a random value as the gap error signal level is reduced through direction control to an opposite direction, the tilt is stopped. Namely, the gap error signal is used as a feedback signal for tilt compensation.

Next, the tilt in a tangential direction is controlled (S40). At this time, the method for compensating the tilt in a radial direction can equally be applied to the tilt in a tangential direction. Namely, the recording medium is tilted at a predetermined angle in a tangential direction with respect to the SIL. At this time, it is determined whether the gap error signal level is reduced and collected to a random value. If the gap error signal level is increased, the recording medium is tilted at a predetermined angle in an opposite tangential direction. In this way, if the gap error signal is reduced and then collected to a random value, the tilt is stopped.

It has been described that tilt compensation in the radial direction is first performed and then tilt compensation in the tangential direction is performed. However, the order of tilt compensation may be changed, and tilt compensations in the two directions may be performed simultaneously.

At this time, the tilt in the radial direction can be compensated by controlling an angle of a pickup device 20 with respect to the recording medium while the tilt in the tangential direction can be compensated by controlling an angle of a disk driver of the recording reproducing apparatus. Alternatively, the tilt compensation can be performed vice versa.

As described above, the angle between the recording medium and the SIL is controlled in due order to search a timing point when the gap error signal is minimized. The reason why that the tilt is controlled in a state that the recording medium is stopped is to prevent the SIL or the recording medium from being damaged and obtain a stable gap error signal by preventing strong collision between the recording medium, which is rotating, and the SIL, wherein the strong collision may occur due to an excessive tilt error.

However, even though the angle between the recording medium and the lens is controlled at the time when the gap error signal is minimized in a state that the recording medium is stopped, it means that the tilt error is locally compensated. When the recording medium is rotated, collision between the recording medium and the SIL may occur due to seismic isolation of the recording medium, or rolling of the gap error signal may be caused by angle change.

Accordingly, the gap error signal is detected (S60) in a state that the recording medium is rotated (S50). The tilt angle is controlled based on the gap error signal in a state that the recording medium is rotated (S70, S80).

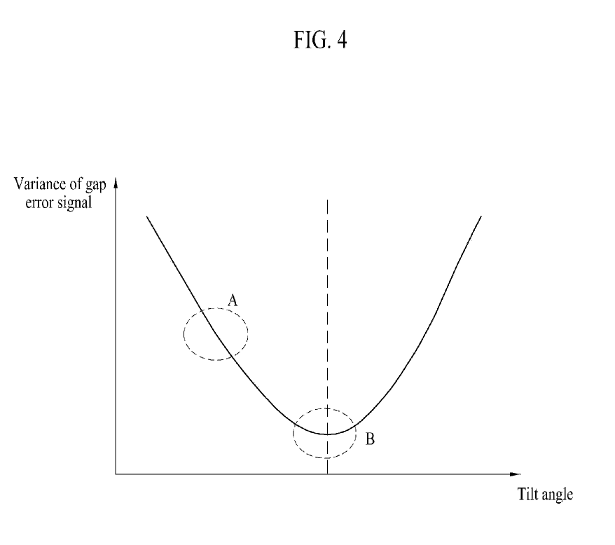

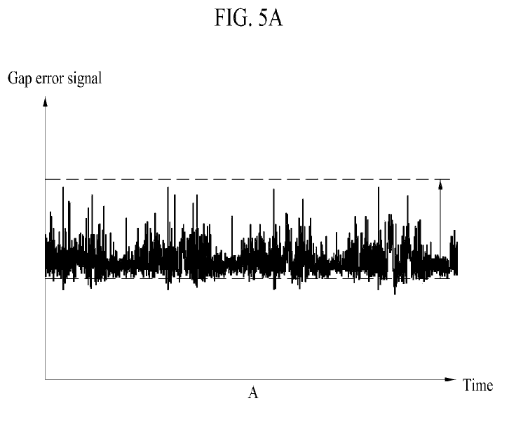

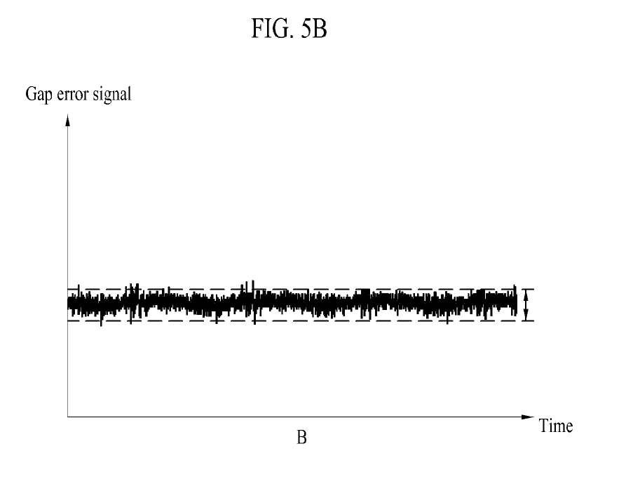

FIG. 4 is a graph illustrating a variance of a gap error signal depending on a tilt angle in a state that a recording medium is rotated, and FIG. 5a and FIG. 5b are graphs illustrating a time variable gap error signal at specific tilt angles (A and B).

As shown, if the tilt error of the recording medium is great, the variance of the gap error signal is great. If the tilt error of the recording medium is small, the variance of the gap error signal is reduced. At this time, if the angle of the recording medium is changed to the time when the variance of the gap error signal is minimized, the angle error between the recording medium and the SIL can be minimized.

As described above, the tilt of the recording medium can be divided into the tilt component in the radial direction and the tilt component in the tangential direction. Accordingly, tilt control for each directional component is required as described in detail below.

First of all, the tilt in the radial direction is controlled (S70). If the variance of the gap error signal is measured in a state that the recording medium is rotated, the recording medium is tilted at a predetermined angle in a radial direction with respect to the SIL. At this time, it is determined whether the variance of the gap error signal is reduced or increased. If the variance of the gap error signal is increased, since it means that the tilt is more increased, the recording medium is tilted at a predetermined angle in an opposite radial direction. If the variance of the initial gap error signal is reduced, or if the variance of the gap error signal is minimized as the variance of the gap error signal is reduced through direction control to an opposite direction, the tilt is stopped.

Next, the tilt in the tangential direction is controlled (S80). At this time, the method for compensating the tilt in the radial direction can equally be applied to the tilt in the tangential direction. Namely, the recording medium is tilted at a predetermined angle in a tangential direction with respect to the SIL. At this time, it is determined whether the variance of the gap error signal is reduced. If the variance of the gap error signal is increased, the recording medium is tilted at a predetermined angle in an opposite tangential direction. In this way, if the variance of the gap error signal is minimized, the tilt is stopped.

It has been described that tilt compensation in the radial direction is first performed and then tilt compensation in the tangential direction is performed. However, the order of tilt compensation may be changed, and tilt compensations in the two directions may be performed simultaneously.

At this time, the tilt in the radial direction can be compensated by controlling an angle of a pickup device 20 with respect to the recording medium while the tilt in the tangential direction can be compensated by controlling an angle of a disk driver of the recording reproducing apparatus. Alternatively, the tilt compensation can be performed vice versa.

Next, recording or reproduction is performed by finely controlling the tilt using an actuator. In a state that the recording medium is stopped and rotated as above, a tilt of a component difficult to compensate using the actuator is compensated using a gap servo signal to desirably perform recording and reproduction.

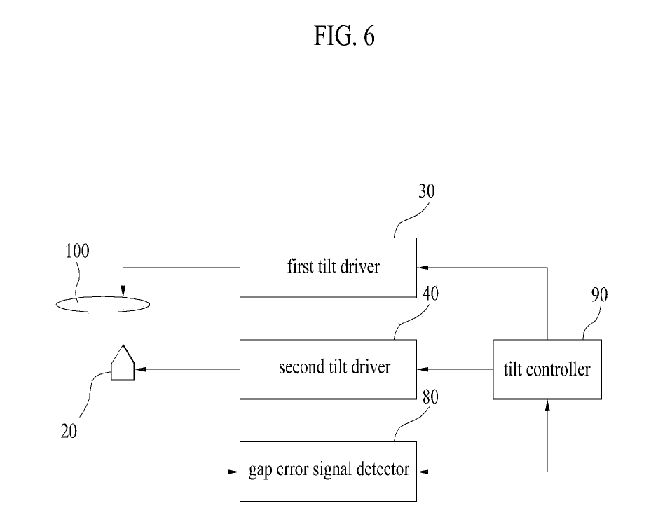

FIG. 6 is a block diagram illustrating a tilt control apparatus according to the embodiment of the present invention. As illustrated in FIG. 6, the tilt control apparatus according to the embodiment of the present invention includes a pickup device 20, a first tilt driver 30, a second tilt driver 40, a gap error signal detector 80, and a tilt controller 90.

The pickup device 20 records data in a recording medium 100 by irradiating light to the recording medium 100 or reproduces the data recorded in the recording medium 100. In this embodiment, the pickup device 20 includes SIL that allows near field.

The first tilt driver 30 controls a tilt by controlling an angle of the recording medium 100 under the control of the tilt controller 90. At this time, the first tilt driver 30 can control the tilt of the recording medium 100.

The second tilt driver 40 controls a tilt by controlling an angle of the pickup device 20 under the control of the tilt controller 90. At this time, the second tilt driver 40 can control the tilt of the recording medium 100.

The gap error signal detector 80 detects a gap error signal based on an optical signal input from the pickup device 20, and transfers the detected gap error signal to the tilt controller 90 to perform tilt control.

The tilt controller 90 determines a tilt in accordance with the gap error signal input from the gap error signal detector 80 and controls the first tilt driver 30 and the second tilt driver 40 to compensate the tilt based on the determined result.

The gap error signal detected from the gap error signal detector 80 is converted to a gap error signal level, which is represented by a specific voltage value, by the tilt controller 90. The measured gap error signal level is transferred to the first and second tilt drivers 30 and 40 and then used for compensation of the tilt.

The tilt controller 90 determines whether the gap error signal level or the variance of the gap error signal is increased or reduced. If the gap error signal level or the variance of the gap error signal is reduced, the tilt controller 90 determines whether the gap error signal level or the variance of the gap error signal reaches a minimum value, and provides the determined result to the first tilt driver 30 and the second tilt driver 40.

The first tilt driver 30 and the second tilt driver 40, which have received a control signal from the tilt controller 90, respectively compensate the tilt of the recording medium 100 in the tangential direction and the radial direction. The tilt controller 90 can be configured in software or hardware, or in combination of software and hardware. Only one tilt controller 90 may be provided, or a plurality of tilt controllers 90 can be provided.

At this time, the first tilt driver 30 and the second tilt driver 40 control the tilt by tilting the pickup device 20 or the recording medium 100.

The respective elements of the aforementioned tilt control apparatus can be configured in software or hardware to perform the aforementioned functions, or can be configured in combination of software and hardware.

Hereinafter, a detailed example of the recording reproducing apparatus for performing tilt control will be described with reference to the accompanying drawing. The apparatus described hereinafter is only exemplary to describe the present invention, and the present invention is not limited to the following description.

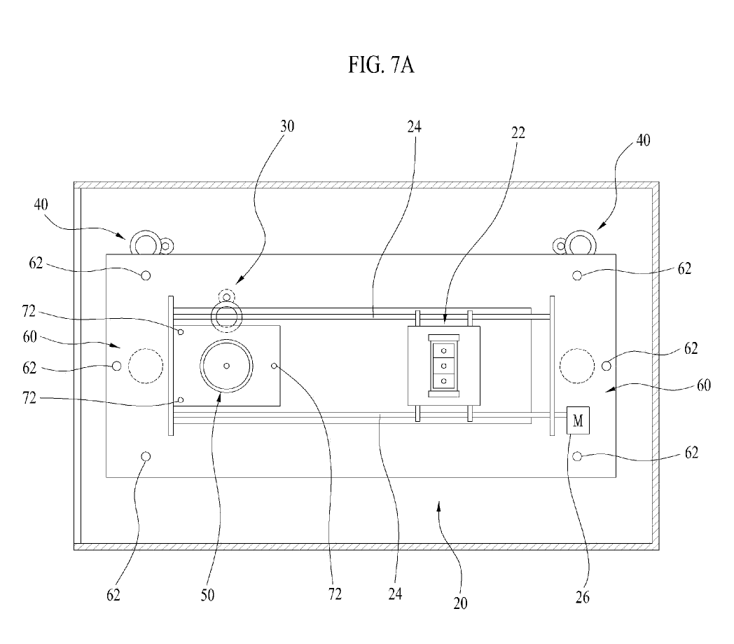

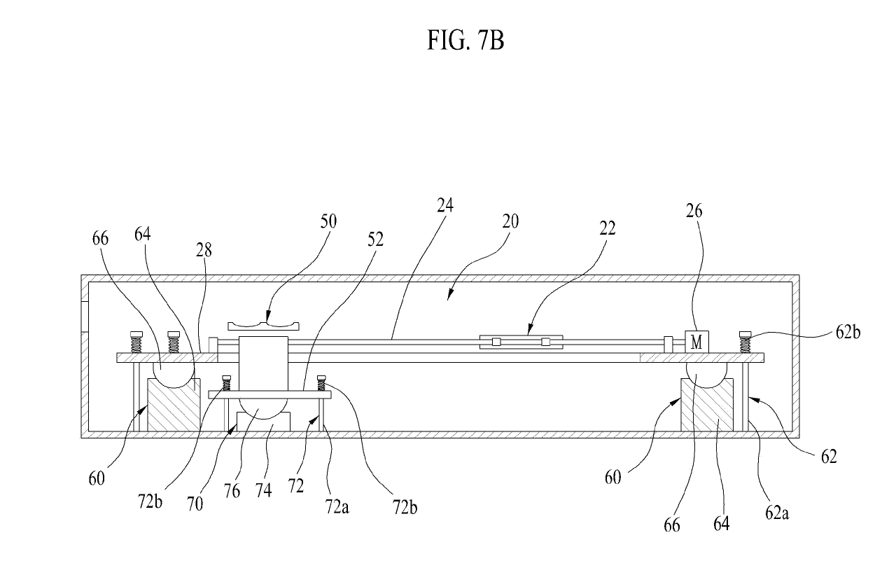

FIG. 7a is a plane view illustrating an example of a recording reproducing apparatus according to the embodiment of the present invention, and FIG. 7b is a sectional view of FIG. 7a. As shown, the recording reproducing apparatus includes a pickup device 20, a first tilt driver 30, a second tilt driver 40, a disk driver 50, and first and second rotation support assemblies 60 and 70.

The pickup device 20 includes a pickup driving unit 26, a pickup unit 22 fed by the pickup driving unit 26, a guide rail 24 guiding feeding of the pickup unit 22, and a pickup device base 28 for mounting the units.

The first tilt driver 30 compensates a tilt of the recording medium by controlling an angle of the disk driver 50. The second tilt driver 40 compensates the tilt of the recording medium by controlling an angle of the pickup device 20.

The disk driver 50 includes a driving motor 54, and a driving unit base 52 provided with the driving motor 54.

The first rotation support assembly 60 and the second rotation support assembly 70 are respectively connected with the second tilt driver 40 and the first tilt driver 30.

The first rotation support assembly 60 and the second rotation support assembly 70 respectively include elastic support units 62 and 72, hinge supports 64 and 74, and hinges 66 and 76. Also, the elastic support units 62 and 72 respectively include clamp shafts 62a and 72a and elastic members 62b and 72b.

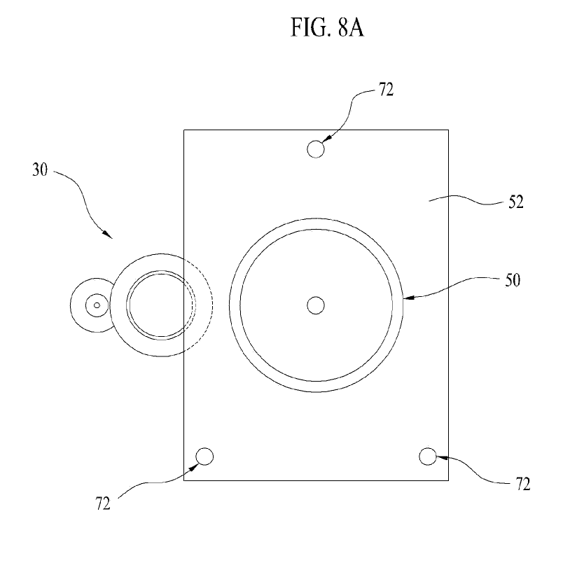

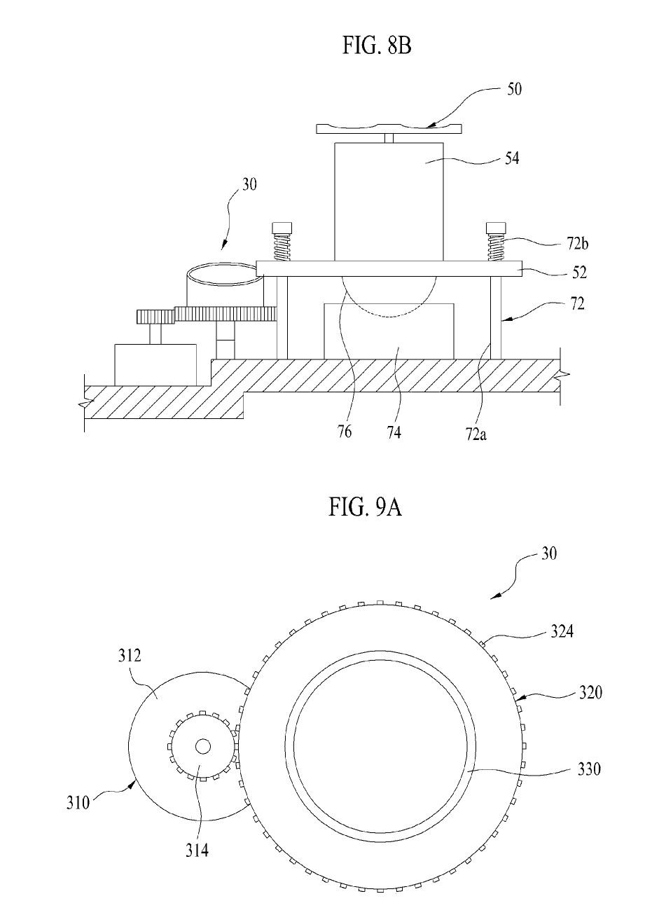

Hereinafter, angle control of the disk driver 50 through the operation of the first tilt driver 30 will be described in detail with reference to FIG. 8a and FIG. 8b.

The first tilt driver 30 is provided to tilt the driving unit base 52 provided with the driving motor 54.

The hinge 76 of a dome shape and the hinge support 74 are provided at the lower part of the driving unit base 52.

The driving unit base 52 can be tilted to correspond to the recording medium by the hinge 76 and the hinge support 74.

In a state that the driving unit base 52 is rotated (tilt driving) at a certain angle by the hinge 76 and the hinge support 74, the elastic support unit 72 that applies a rotational force to the driving base unit 52 is provided in the driving unit base 52. The elastic support unit 72 includes the clamp shaft 72a and the elastic member 72b.

The clamp shaft 72a constituting the elastic support unit 72 as above may be provided to pass through the driving unit base 52, or may be provided to adjoin the driving unit base 52. The elastic member 72b is arranged between the clamp shaft 72a and the driving unit base 52 to apply elasticity to the driving unit base 52. Namely, the driving unit base 52 can be configured to be pushed downwardly.

The elastic support unit 72 can be configured based on the hinge 76 and the hinge support 74 to apply a potential rotational force to one side of the driving base unit 52. At this time, the potential rotational force applied to the driving unit base 52 by the elastic support unit 72 will be applied to a direction where the first tilt driver 30 which will be described later is located. This is because that the rotational force should be applied to the driving unit base 52 by the first tilt driver 30 in an opposite direction of the direction of the rotational force applied to the driving unit base 52 by the elastic support unit 72 based on the hinge 76 and the hinge support 74.

The first tilt driver 30 and the second tilt driver 40 are comprised of a cam structure so that the driving base unit 52 and the pickup device 20 can be tilted, respectively.

The first tilt driver 30 and the second tilt driver 40 include a cam structure and a driving motor that can rotate the cam structure. The first tilt driver 30 and the second tilt driver 40 will be described in detail. Hereinafter, the first tilt driver 30 will exemplarily be described, and the description of the second tilt driver 40 similar to the first tilt driver 30 will be omitted.

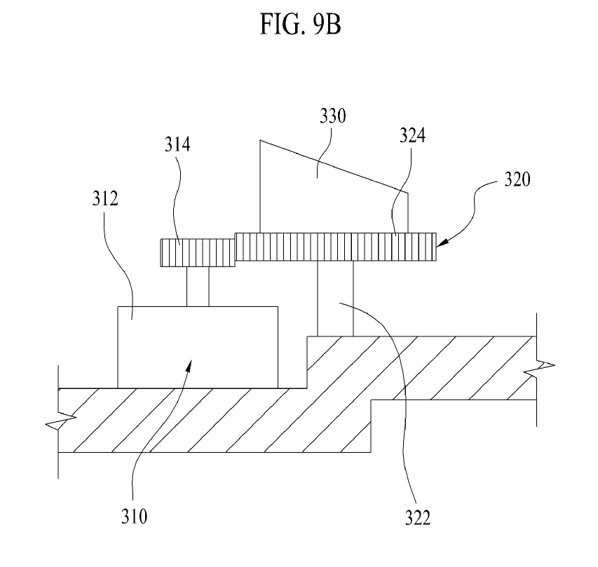

FIG. 9a and FIG. 9b are plane view and sectional view illustrating the first tilt driver 30. As illustrated in FIG. 9a and FIG. 9b, the first tilt driver 30 includes a driving gear 310 generating a rotational force, a tilting driving unit base 320 receiving the rotational force from the driving gear 310, and a cam unit 330 fixed to the tilting driving unit base 320 and arranged to adjoin the driving unit base 52.

The first tilt driver 30 arranged to adjoin the driving unit base 52 will be described in more detail. A gear 324 is formed at a side of the tilting driving unit base 320 constituting the first tilt driver 30, a rotation shaft 322 is provided below the tilting driving unit base 320, and the cam unit 330 is provided on the tilting driving unit base 320.

According to the aforementioned configuration, the tilting driving unit base 320 provided with the gear 325 at the side is arranged at one side of the driving unit base 52 by the rotation shaft 322 provided below the tilting driving unit base 320.

The cam unit 330 fixed onto the tilting driving unit base 320 is configured to apply the rotational force to the driving unit base 52 in an opposite direction of the direction of the rotational force applied by the elastic support unit 72 based on the hinge 76 and the hinge support 74 in contact with one end of the driving unit base 52.

The driving gear 310 includes a driving motor 312 generating a rotational force, and a gear unit 314 for transferring the rotational force generated from the driving motor 312 to the tilting driving unit base 320.

The gear unit 314 is configured to apply the rotational force in a state that it is engaged with the gear 324 formed at the side of the tilting driving unit base 320. The gear unit 314 may be comprised of a plurality of gear assemblies, or may be comprised of a pinion gear generally fixed to the driving motor 312.

In accordance with the aforementioned configuration, the rotational force generated by the driving motor 312 is transferred to the cam unit 330 through the gear unit 314 and the tilting driving unit base 320. The cam unit 330 is rotated by the rotational force in a state that its upper surface adjoins the end of the driving unit base 52.

When a peak point, the lowest point, or a center point of the cam unit 330 is located at the end of the driving unit base 52 by the aforementioned rotation, the rotation state of the driving unit 52 is determined as a clockwise, counterclockwise, or parallel state based on the hinge 76 and the hinge support 74.

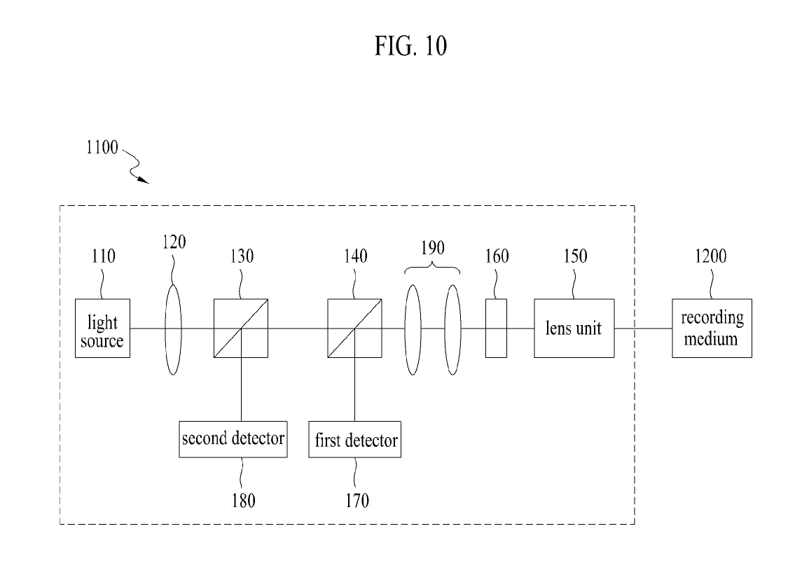

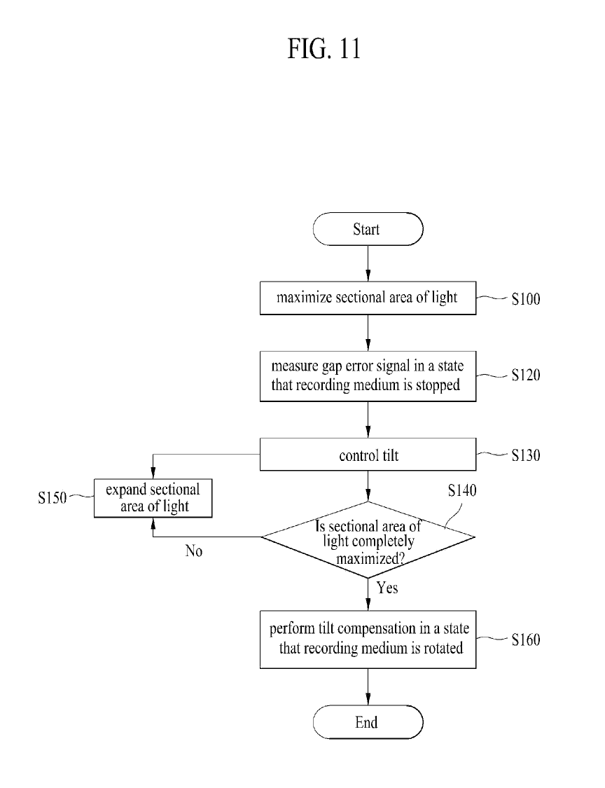

FIG. 10 is a block diagram illustrating a recording reproducing apparatus according to the embodiment of the present invention. The recording reproducing apparatus is configured to detect light irradiated from a pickup 1100 and reflected on a recording medium 1200, and control tilt or trace of a track to correspond to the detected light, thereby irradiating the light to the exact position. Hereinafter, an optical system included in the pickup 1100 will be described in detail.

The pickup 1100 includes a light source 110. The light source 110 could be a laser having good straightness, such as a laser diode. The light irradiated from the light source 110 to the recording medium could be parallel light. Accordingly, the recording reproducing apparatus according to the embodiment of the present invention includes a collimate lens 120 makes a path of the light emitted from the light source 110 parallel.

Split synthesizers 130 and 140 split the path of light entered from one direction or synthesize paths of light entered from different directions. A data recording apparatus according to the embodiment of the present invention includes a first split synthesizer 130 and a second split synthesizer 140.

The first split synthesizer 130 partially transmits and reflects incident light. For example, the first split synthesizer 130 could be a non-polarized beam splitter. The second split synthesizer 140 could be a polarized beam splitter that transmits polarized light of a specific direction in accordance with a polarized direction. If linear polarized light is used, the second split synthesizer 140 can be configured to transmit polarized components of a vertical direction and reflect polarized components of a horizontal direction. By contrast, the second split synthesizer 140 may be configured to transmit the polarized components of the horizontal direction and reflect the polarized components of the vertical direction.

A lens unit 150 is located near the recording medium 1200 to irradiate light to a given region of the recording medium 1200.

A light convert surface 160 and an expander 190 are provided between the lens unit 150 and the second beam splitter 140. The light convert surface 160 converts a polarized direction of light entered and reflected from the recording medium 1200. If the light convert surface 160 is a quarter wave plate, the light convert surface 160 polarizes the light entered the recording medium 1200 counterclockwise, and polarizes the light reflected on the recording medium 1200 clockwise. As a result, the reflected light transmitting the light convert surface 160 is polarized in a direction different from that of the incident light. Phase difference of 90° occurs between the reflected light and the incident light.

Accordingly, the reflected light of which polarized direction is converted as above is reflected without transmitting the second beam splitter 140 through which the incident light is transmitted, and enters a first detector 170. At this time, a part of the reflected light is polarized and then transmits the second beam splitter. Then, the part of the reflected light is reflected on the first beam splitter 130 and then enters a second detector 180. This is because that the part of the reflected light is polarized as the lens unit 150 has a numerical aperture greater than 1.

The first detector 170 and the second detector 180 receive the reflected light and generate an electric signal corresponding to the reflected light. In the embodiment of the present invention, the first detector 170 and the second detector 180 respectively generate a tilt error signal and a gap error signal.

The expander 190 controls a sectional size of the incident light. Particularly, in the second embodiment of the present invention which will be described later, the expander 190 makes a sectional area of the light entering the lens unit 150 great so as to more efficiently perform tilt control.

FIG. 11 is a flow chart illustrating a tilt control method of a recording medium according to the second embodiment of the present invention. In a tilt control procedure of the recording medium, a contact condition is set with respect to a part where the light is actually located in the SIL. Accordingly, if a sectional area of light entering a bottom surface of the SIL or emitted from the bottom surface of the SIL has a large size, it is advantageous to acquire a signal for tilt control. In this respect, in this embodiment, the sectional are of the light entering the lens unit is maximized using the expander 190 (S100). At this time, it is possible to increase the sectional area of the light by controlling a relative position of the expander 190.

Next, in the same manner as the first embodiment of the present invention, in a state that the recording medium is stopped, the gap error signal is measured (S120), and a tilt is controlled in a radial direction and a tangential direction (S130).

Subsequently, it is determined whether the sectional area of the light has been completely maximized to correspond to the size of the SIL where the light enters (S140). At this time, variation of a contact level according to expansion of the sectional area of the light is stored in a separate system memory, and gap servo is only operated to finally verify the set contact condition.

An initial tilt condition can be set uniformly and exactly for the entire bottom surface of the SIL through the initial condition procedure of the tilt between the disk and the bottom surface of the SIL in the expanded sectional area state of the light with respect to the bottom surface of the SIL.

At this time, if it is determined that the sectional area of the light has not been maximized, the sectional area of the light is again controlled using the expander 190 (S150).

If it is determined that the sectional area of the light has been maximized, for example, if the size of the bottom surface of the SIL is equivalent to that of the sectional area of the light, tilt compensation of the recording medium is performed (S160) as described in the first embodiment in a state that the recording medium is rotated.

According to this embodiment, the contact and tilt condition can be set for a broader bottom surface of the SIL. Accordingly, it is possible to actually improve stability of the gap servo.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

What is claimed is:

1. A tilt control method of a recording medium, the tilt control method comprising:
fixing the recording medium to a recording reproducing apparatus;
performing first tilt compensation in a state that the recording medium is stopped; and
performing second tilt compensation in a state that the recording medium in which the first tilt compensation has been performed is rotated.

2. The tilt control method as claimed in claim 1 wherein the step of performing first tilt compensation includes:
detecting a gap error signal from the recording medium; and
controlling an angle of the recording medium based on the detected gap error signal.

3. The tilt control method as claimed in claim 2, wherein the step of controlling an angle of the recording medium includes:
controlling a tilted angle in a radial direction of the recording medium; and
controlling a tilted angle in a tangential direction of the recording medium.

4. The tilt control method as claimed in claim 2 wherein the angle of the recording medium is controlled so that the gap error signal reaches a minimum value.

5. The tilt control method as claimed in claim 2, wherein the step of detecting a gap error signal includes:
expanding a size of a sectional area of a light for detecting the gap error signal; and
detecting the gap error signal from the expanded light.

6. The tilt control method as claimed in claim 5, wherein the step of expanding a size of a sectional area of a light further includes maximizing the sectional area of the light to correspond to a size of a lens where the light enters.

7. The tilt control method as claimed in claim 1 wherein the step of performing second tilt compensation includes:
detecting a gap error signal in a state that the recording medium is rotated; and
controlling an angle of the recording medium based on the detected gap error signal.

8. The tilt control method as claimed in claim 7, wherein the step of controlling an angle of the recording medium includes:
controlling a tilted angle in a radial direction of the recording medium; and
controlling a tilted angle in a tangential direction of the recording medium.

9. The tilt control method as claimed in claim 7, wherein the angle of the recording medium is controlled so that size variation of the gap error signal is minimized.

10. The tilt control method as claimed in claim 1, wherein the recording medium is a near field optical recording medium, and the recording reproducing apparatus is a near field optical recording reproducing apparatus.

11. A tilt control apparatus of a recording medium, the tilt control apparatus comprising:
a tilt driver controlling a tilted angle of the recording medium; and
a tilt controller controlling the tilt driver to perform tilt control in each of a state that the recording medium is stopped and a state that the recording medium is rotated.

12. The tilt control apparatus as claimed in claim 11, wherein the tilt driver includes:
a first tilt driver controlling a tilted angle in a tangential direction of the recording medium; and
a second tilt driver controlling a tilted angle in a radial direction of the recording medium.

13. The tilt control apparatus as claimed in claim 11, further comprising a gap error signal detector detecting a gap error signal from the recording medium, wherein the tilt controller controls the tilt driver based on the gap error signal input from the gap error signal detector.

14. The tilt control apparatus as claimed in claim 13, wherein the tilt controller controls the tilt driver to obtain a minimum value of the gap error signal in a state that the recording medium is stopped.

15. The tilt control apparatus as claimed in claim 13, further comprising an expander expanding a size of a sectional area of light for detecting the gap error signal.

16. The tilt control apparatus as claimed in claim 15, wherein the expander maximizes the sectional area of the light to correspond to a size of a lens where the light enters.

17. The tilt control apparatus as claimed in claim 13, wherein the tilt controller controls the tilt driver so that size variation of the gap error signal is minimized.

18. The tilt control apparatus as claimed in claim 11, wherein the recording medium is an optical recording medium using near field.
